(19) United States
(12) Patent Application Publication
(10) Pub. No.: US 2024/0051548 A1
(43) Pub. Date: Feb. 15, 2024

(54) SUPERVISORY ELECTRICAL CONTROL ARCHITECTURE FOR AV AND MANUAL DRIVING

(71) Applicant: GM Global Technology Operations LLC, Detroit, MI (US)

(72) Inventors: Yubiao Zhang, Sterling Heights, MI (US); SeyedAlireza Kasaiezadeh Mahabadi, Novi, MI (US); Nikolai K. Moshchuk, Grosse Pointe Farms, MI (US); Saurabh Kapoor, Markham (CA); Ruixing Long, Novi, MI (US); Bharath Pattipati, South Lyon, MI (US); David Perez-Chaparro, Ferndale, MI (US)

(21) Appl. No.: 17/818,992

(22) Filed: Aug. 11, 2022

(51) Int. Cl. B60W 40/105; B60W 40/114

(52) U.S. Cl. CPC B60W 40/105; B60W 40/114; B60W 2552/30; B60W 2510/20; B60W 2554/4041

(57) ABSTRACT

A system comprises a computer including a processor and a memory. The memory includes instructions such that the processor is programmed to generate vehicle-level commands based on received vehicle operation commands. The received vehicle operation commands can comprise input commands corresponding to at least one of an autonomous vehicle (AV) mode of operation or a manual mode of operation. The processor is also programmed to generate target actuator commands based on the vehicle-level commands and transmit the target actuator commands to at least one actuator.

### INTRODUCTION

The present disclosure relates to a vehicle motion control system that can translate vehicle-level commands to target actuator commands.

Vehicles can include vehicle motion control systems that influence longitudinal, lateral, and vertical dynamics of a vehicle. These systems can include mechanical components that relate to steering and braking as well as software components that determine and control driving strategy and/or planning.

### SUMMARY

A system comprises a computer including a processor and a memory. The memory includes instructions such that the processor is programmed to generate vehicle-level commands based on received vehicle operation commands. The received vehicle operation commands can comprise input commands corresponding to at least one of an autonomous vehicle (AV) mode of operation or a manual mode of operation. The processor is also programmed to generate target actuator commands based on the vehicle-level commands and transmit the target actuator commands to at least one actuator.

In other features, the processor is further programmed to receive the vehicle-level commands.

In other features, the vehicle-level commands comprise a speed profile data, a front steering command, road bank data, road grade data, and road curvature data during the AV mode of operation.

In other features, the processor is further programmed to translate the speed profile data, the front steering command, the road bank data, the road grade data, and the road curvature data to a corresponding yaw rate and relative positional data.

In other features, the vehicle-level commands comprise a drive torque request, a brake torque request, a front steering command, road bank data, road grade data, and road curvature data during the manual mode of operation.

In other features, the processor is further programmed to translate the drive torque request, the brake torque request, the front steering command, the road bank data, the road grade data, and the road curvature data to a corresponding yaw rate and relative positional data.

In other features, the at least one actuator actuates a vehicle component according to the target actuator commands.

A vehicle can include a computer that includes a processor and a memory. The memory includes instructions such that the processor is programmed to generate vehicle-level commands based on received vehicle operation commands, wherein the received vehicle operation commands comprise input commands corresponding to at least one of an autonomous vehicle (AV) mode of operation or a manual mode of operation and generate target actuator commands based on the vehicle-level commands. The processor is also programmed to generate target actuator commands based on the vehicle-level commands and transmit the target actuator commands to at least one actuator.

In other features, the processor is further programmed to receive the vehicle-level commands.

In other features, the vehicle-level commands comprise a speed profile data, a front steering command, road bank data, road grade data, and road curvature data during the AV mode of operation.

In other features, the processor is further programmed to translate the speed profile data, the front steering command, the road bank data, the road grade data, and the road curvature data to a corresponding yaw rate and relative positional data.

In other features, the vehicle-level commands comprise a drive torque request, a brake torque request, a front steering command, road bank data, road grade data, and road curvature data during the manual mode of operation.

In other features, the processor is further programmed to translate the drive torque request, the brake torque request, the front steering command, the road bank data, the road grade data, and the road curvature data to a corresponding yaw rate and relative positional data.

In other features, the at least one actuator actuates a vehicle component according to the target actuator commands.

A method includes generating vehicle-level commands based on received vehicle operation commands, wherein the received vehicle operation commands comprise input commands corresponding to at least one of an autonomous vehicle (AV) mode of operation or a manual mode of operation and generating target actuator commands based on the vehicle-level commands. The method also includes transmitting the target actuator commands to at least one actuator.

In other features, the method also includes receiving the vehicle-level commands.

In other features, the vehicle-level commands comprise a speed profile data, a front steering command, road bank data, road grade data, and road curvature data during the AV mode of operation.

In other features, the method includes translating the speed profile data, the front steering command, the road bank data, the road grade data, and the road curvature data to a corresponding yaw rate and relative positional data.

In other features, the vehicle-level commands comprise a drive torque request, a brake torque request, a front steering command, road bank data, road grade data, and road curvature data during the manual mode of operation.

In other features, the method includes translating the drive torque request, the brake torque request, the front steering command, the road bank data, the road grade data, and the road curvature data to a corresponding yaw rate and relative positional data.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of an example system including a vehicle;

FIG. 2 is a block diagram of an example computing device;

FIG. 3 is a diagram illustrating an example control system for translating vehicle operation commands to vehicle-level commands; and

FIG. 4 is a flow diagram illustrating an example process for translating vehicle operation commands to vehicle-level commands.

### DETAILED DESCRIPTION

The following description is merely exemplary in nature and is not intended to limit the present disclosure, application, or uses.

Currently, an electrical control architecture for vehicle control systems are designed for either a manual mode of operation or an autonomous vehicle (AV) mode of operation. The present disclosure is directed to a control system that defines an interface and functionality to support both AV modes of operation and manual modes of operation.

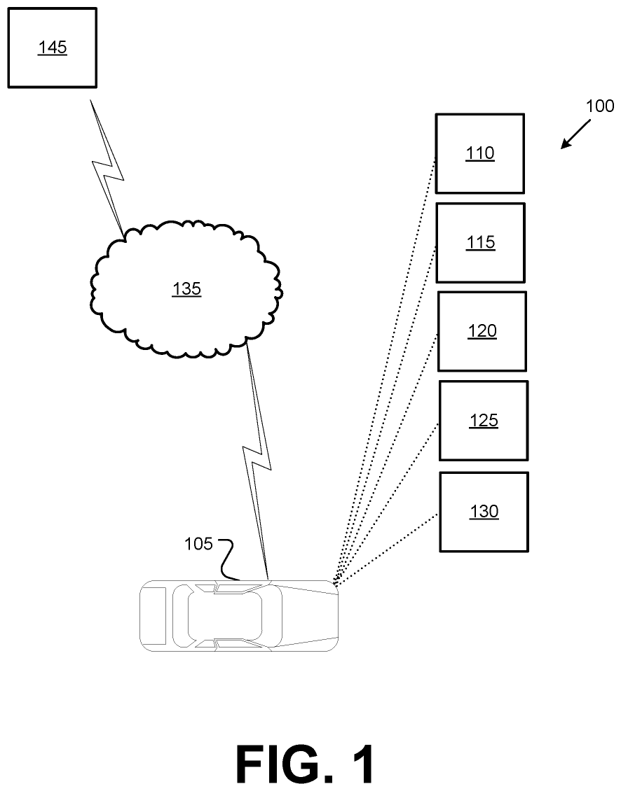

FIG. 1 is a block diagram of an example system 100. The system 100 includes a vehicle 105, which can comprise a land vehicle such as a car, truck, etc., an aerial vehicle, and/or an aquatic vehicle. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

The computer 110 can include one or more suitable planning modules and/or suitable perception modules that operate the vehicle 105 according to determined driving plans when the vehicle 105 is operating in a semi-autonomous mode of operation or an autonomous mode of operation. For example, the planning modules and/or the perception modules can cause the vehicle 105 to traverse a driving path according to the driving plan and perceived environment.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110. The vehicle 105 communications network can include one or more gateway modules that provide interoperability between various networks and devices within the vehicle 105, such as protocol translators, impedance matchers, rate converters, and the like.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects, etc., relative to the location of the vehicle 105. The vehicle sensors 115 may further include camera sensor(s) 115, e.g., front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation-such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle to vehicle (V2V) or vehicle-to-infrastructure (V2I) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short-range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

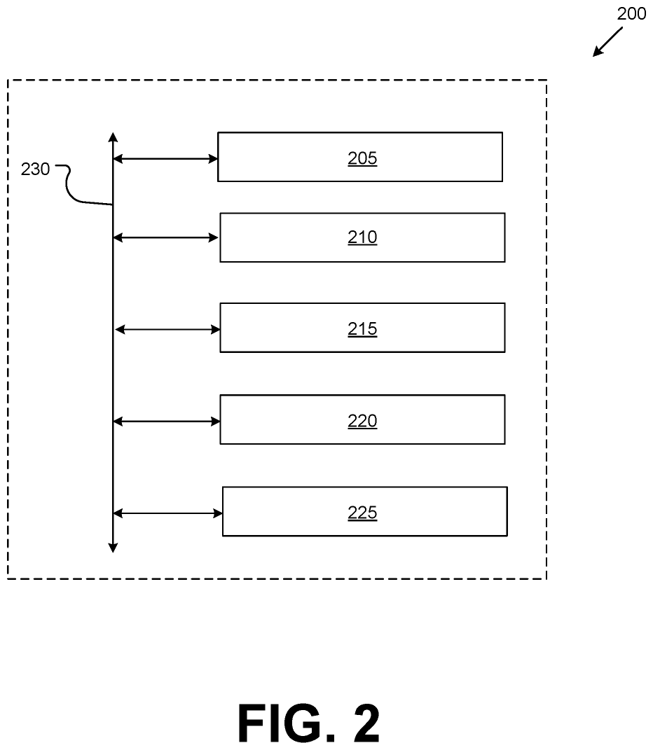

FIG. 2 illustrates an example computing device 200 i.e., computer 110, server(s) 145, that may be configured to perform one or more of the processes described herein. As shown, the computing device can comprise a processor 205, memory 210, a storage device 215, an I/O interface 220, and a communication interface 225. Furthermore, the computing device 200 can include an input device such as a touchscreen, mouse, keyboard, etc. In certain implementations, the computing device 200 can include fewer or more components than those shown in FIG. 2.

In particular implementations, processor(s) 205 includes hardware for executing instructions, such as those making up a computer program. As an example, and not by way of limitation, to execute instructions, processor(s) 205 may retrieve (or fetch) the instructions from an internal register, an internal cache, memory 210, or a storage device 215 and decode and execute them.

The computing device 200 includes memory 210, which is coupled to the processor(s) 205. The memory 210 may be used for storing data, metadata, and programs for execution by the processor(s). The memory 210 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 210 may be internal or distributed memory.

The computing device 200 includes a storage device 215 includes storage for storing data or instructions. As an example, and not by way of limitation, storage device 215 can comprise a non-transitory storage medium described above. The storage device 215 may include a hard disk drive (HDD), flash memory, a Universal Serial Bus (USB) drive or a combination of these or other storage devices.

The computing device 200 also includes one or more input or output (“I/O”) devices/interfaces 220, which are provided to allow a user to provide input to (such as user strokes), receive output from, and otherwise transfer data to and from the computing device 200. These I/O devices/interfaces 220 may include a mouse, keypad or a keyboard, a touch screen, camera, optical scanner, network interface, modem, other known I/O devices or a combination of such I/O devices/interfaces 220. The touch screen may be activated with a writing device or a finger.

The I/O devices/interfaces 220 may include one or more devices for presenting output to a user, including, but not limited to, a graphics engine, a display (e.g., a display screen), one or more output drivers (e.g., display drivers), one or more audio speakers, and one or more audio drivers. In certain implementations, devices/interfaces 220 is configured to provide graphical data to a display for presentation to a user. The graphical data may be representative of one or more graphical user interfaces and/or any other graphical content as may serve a particular implementation.

The computing device 200 can further include a communication interface 225. The communication interface 225 can include hardware, software, or both. The communication interface 225 can provide one or more interfaces for communication (such as, for example, packet-based communication) between the computing device and one or more other computing devices 200 or one or more networks. As an example, and not by way of limitation, communication interface 225 may include a network interface controller (NIC) or network adapter for communicating with an Ethernet or other wire-based network or a wireless NIC (WNIC) or wireless adapter for communicating with a wireless network, such as a WI-FI. The computing device 200 can further include a bus 230. The bus 230 can comprise hardware, software, or both that couples components of the computing device 200 to each other.

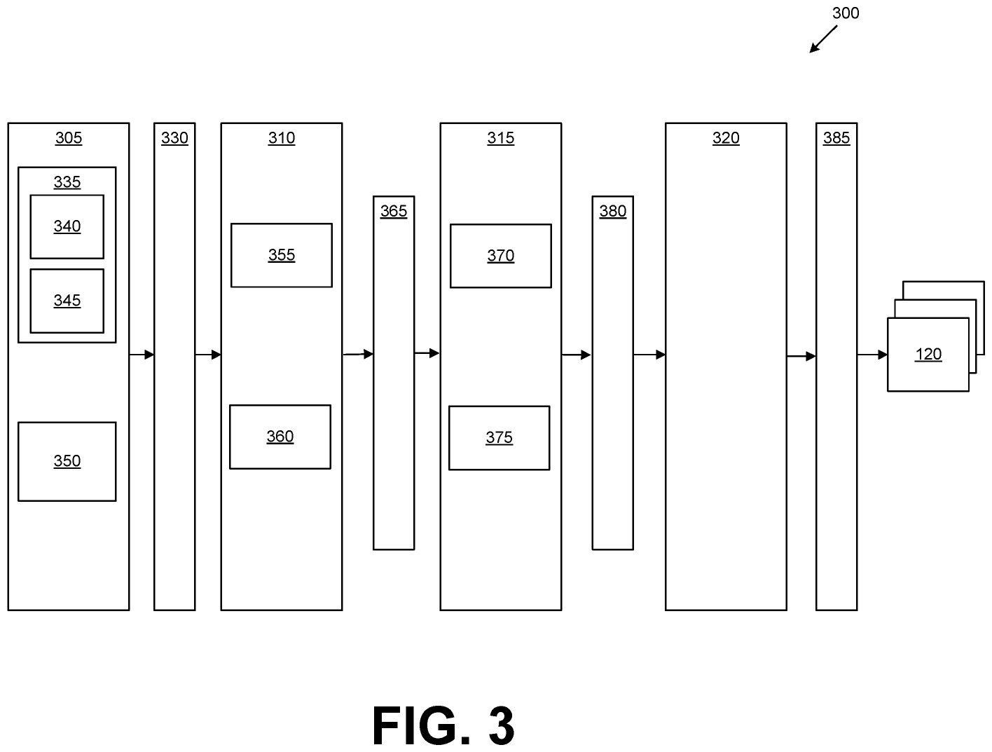

FIG. 3 is a functional block diagram of an example control system 300 for the vehicle 105. As shown, the control system 300 includes a command input module 305, a request interpretation module 310, a control translation module 315, and a feature coordination module 320. As discussed in greater detail herein, the control system 300 translates vehicle operation commands to vehicle-level commands for controlling vehicle 105 operation.

The vehicle operation commands can include, but are not necessarily limited to, input commands corresponding to a manual mode of operation or input commands corresponding to an autonomous vehicle (AV) mode of operation. In an example implementation, input commands corresponding to the manual mode of operation can comprise a drive torque request, a brake torque request, a front steering command, road bank data, road grade data, road curvature data, and the like. Input commands corresponding to the AV mode of operation can comprise a speed profile data, a front steering command, road bank data, road grade data, road curvature data, and the like. In one or more implementations, vehicle operation commands can be received from one or more components 125 and/or the computer 110.

Depending on the mode of operation of the vehicle 105, the command input module 305 provides the respective vehicle operation commands to an interface 330 that routes the vehicle operation commands to the request interpretation module 310. The input corresponding to the AV mode of operation 335 can be generated based on output from a perception module 340 and/or a planning module 345. The input corresponding to the manual mode of operation 350 can be provided by one or more components 125 and/or the computer 110.

The request interpretation module 310 can generate vehicle-level commands used for path tracking when the vehicle 105 is in the AV mode of operation and can determine vehicle-level commands for vehicle 105 dynamic performance. For example, as shown, the request interpretation module 310 includes an autonomous vehicle (AV) command interpreter 355 and a driver command interpreter 360. During operation, vehicle operation commands corresponding to the AV mode of operation are received by the AV command interpreter 355 via the interface 330, and vehicle operation command corresponding to the manual mode of operation are received by the driver command interpreter 360 via the interface 330.

The AV command interpreter 355 receives road bank data, road grade data, road curvature data, speed profile data, and the front steering command and translates this received input to corresponding yaw rate, relative positional data represented within a Cartesian coordinate system, and a speed reference, which are provided to an interface 365 as input.

The driver command interpreter 360 receives the drive torque request, the brake request, the front steering command, the road bank data, the road grade data, and the road curvature data and translates this received input to corresponding yaw rate, relative positional data represented within a Cartesian coordinate system, and a speed reference, which are provided to the interface 365 as input.

In various implementations, the AV command interpreter 355 and the driver command interpreter 360 comprise respective lookup tables that relate input, i.e., vehicle operation commands, to corresponding output, i.e., yaw rate, relative positional data, and a speed reference. It is understood that the lookup tables can be developed based on empirical analysis. In some implementations, an extended bicycle model can be used to provide extended references of space and state data pertaining to the vehicle 105 based on the received vehicle operation commands.

The interface 365 provides the yaw rate, relative positional data, and the speed reference to the control translation module 315 as input. The control translation module 315 can determine actuator commands for one or more actuators 120 of the vehicle 105 based on the received input. As shown, the control translation module 315 includes an autonomous vehicle (AV) control module 370 and a vehicle-level control module 375.

During the AV mode of operation, the AV control module 370 receives the yaw rate, relative positional data, and the speed reference and generates a modified path to traverse based on the received input. In various implementations, the AV control module 370 can include a suitable Model Predictive Controller (MPC) that tracks an original path based on received friction data and re-plans the path to traverse.

During the manual mode of operation, the vehicle-level control module 375 receives the yaw rate, relative positional data, and the speed reference and generates a corrected yaw moment based on the received data. The vehicle-level control module 375 can also generate a total force request for at least one of the vehicle 105 wheels. In various implementations, the vehicle-level control module 375 includes a proportional-integral-derivative (PID) controller or model-based controller to generate the corrected yaw moment and/or the total force request.

The feature coordination module 320 receives the actuator commands from an interface 380. For example, the feature coordination module 320 receives the corrected yaw moment and the total force request when the vehicle 105 is operating in the manual mode of operation. In another example, the feature coordination module 320 receives the modified path to traverse when the vehicle 105 is operating in the AV mode of operation.

The feature coordination module 320 can determine target actuator commands based on the received input. For example, the feature coordination module 320 can determine a total yaw moment about a center-of-gravity of the vehicle 105, the longitudinal force, and the lateral force for performing a vehicle action according to the received actuator commands. The feature coordination module 320 can also translate center-of-gravity moment and/or forces to corresponding tire forces. The feature coordination module 320 can convert the corresponding tire forces to actuator commands. The feature coordination module 320 also determines the one or more target commands, i.e., acceleration command, brake command, etc., that are to be provided to one or more actuators 120.

The feature coordination module 320 can provide the target actuator commands to an interface 385. The interface 385 can then provide the target actuator commands to corresponding actuators 120 within the vehicle 105.

In various implementations, the feature coordination module 320 can comprise a Model Predictive Controller, a lookup table, a multi-layer feature coordination module, or the like. For example, the feature coordination module can use calculated total yaw moment, longitudinal forces, and/or lateral forces to determine the target actuator commands.

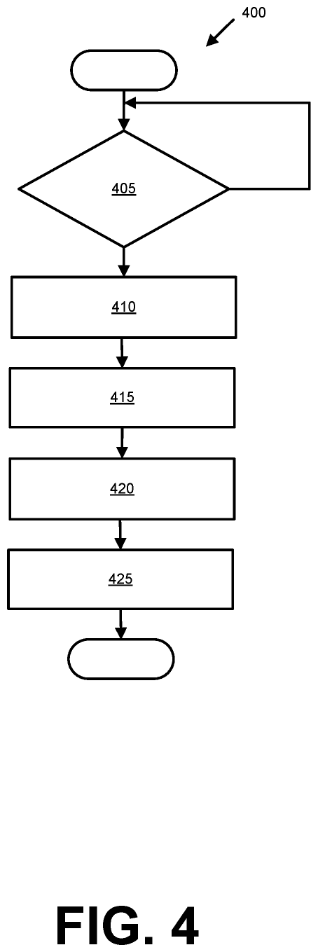

FIG. 4 is a flowchart of an exemplary process 400 for translating vehicle operation commands to vehicle-level commands. Blocks of the process 400 can be executed by the computer 110. The process 400 begins at block 405 in which a determination of whether a vehicle operation command is received. As discussed above, vehicle operation commands can include input commands corresponding to the manual mode of operation or input commands corresponding to the AV mode of operation.

At block 410, the computer 110 can generate vehicle-level commands based on the received vehicle operation commands. For example, the vehicle-level commands can comprise yaw rate, relative positional data represented within a Cartesian coordinate system, and/or a speed reference.

At block 415, the computer 110 generates actuator commands based on the vehicle-level commands. At block 420, the computer 110 generates target actuator commands. In an example implementation, the computer 110 can determine target actuator commands based on a calculated yaw moment, calculated longitudinal forces, and/or calculated lateral forces. Using the calculated yaw moment, calculated longitudinal forces, and/or calculated lateral forces, the computer 110 can determine corresponding target tire forces. The target tire forces can then be converted into actuator commands.

At block 425, the target actuator commands are transmitted to one or more actuators 120. The actuators 120 use the target actuator commands to actuate the vehicle components 125 accordingly. The process 400 then ends.

The description of the present disclosure is merely exemplary in nature and variations that do not depart from the gist of the present disclosure are intended to be within the scope of the present disclosure. Such variations are not to be regarded as a departure from the spirit and scope of the present disclosure.

In general, the computing systems and/or devices described may employ any of a number of computer operating systems, including, but by no means limited to, versions and/or varieties of the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
generate vehicle-level commands based on received vehicle operation commands, wherein the received vehicle operation commands comprise input commands corresponding to at least one of an autonomous vehicle (AV) mode of operation or a manual mode of operation;
generate target actuator commands based on the vehicle-level commands; and
transmit the target actuator commands to at least one actuator.

2. The system of claim 1, wherein the processor is further programmed to receive the vehicle-level commands.

3. The system of claim 2, wherein the vehicle-level commands comprise a speed profile data, a front steering command, road bank data, road grade data, and road curvature data during the AV mode of operation.

4. The system of claim 3, wherein the processor is further programmed to translate the speed profile data, the front steering command, the road bank data, the road grade data, and the road curvature data to a corresponding yaw rate and relative positional data.

5. The system of claim 2, wherein the vehicle-level commands comprise a drive torque request, a brake torque request, a front steering command, road bank data, road grade data, and road curvature data during the manual mode of operation.

6. The system of claim 5, wherein the processor is further programmed to translate the drive torque request, the brake torque request, the front steering command, the road bank data, the road grade data, and the road curvature data to a corresponding yaw rate and relative positional data.

7. The system of claim 1, wherein the at least one actuator actuates a vehicle component according to the target actuator commands.

8. A vehicle comprising a computer including a processor and a memory, the memory including instructions such that the processor is programmed to:
generate vehicle-level commands based on received vehicle operation commands, wherein the received vehicle operation commands comprise input commands corresponding to at least one of an autonomous vehicle (AV) mode of operation or a manual mode of operation;
generate target actuator commands based on the vehicle-level commands; and
transmit the target actuator commands to at least one actuator.

9. The vehicle of claim 8, wherein the processor is further programmed to receive the vehicle-level commands.

10. The vehicle of claim 9, wherein the vehicle-level commands comprise a speed profile data, a front steering command, road bank data, road grade data, and road curvature data during the AV mode of operation.

11. The vehicle of claim 10, wherein the processor is further programmed to translate the speed profile data, the front steering command, the road bank data, the road grade data, and the road curvature data to a corresponding yaw rate and relative positional data.

12. The vehicle of claim 9, wherein the vehicle-level commands comprise a drive torque request, a brake torque request, a front steering command, road bank data, road grade data, and road curvature data during the manual mode of operation.

13. The vehicle of claim 12, wherein the processor is further programmed to translate the drive torque request, the brake torque request, the front steering command, the road bank data, the road grade data, and the road curvature data to a corresponding yaw rate and relative positional data.

14. The vehicle of claim 8, wherein the at least one actuator actuates a vehicle component according to the target actuator commands.

15. A method comprising:
generating vehicle-level commands based on received vehicle operation commands, wherein the received vehicle operation commands comprise input commands corresponding to at least one of an autonomous vehicle (AV) mode of operation or a manual mode of operation;
generating target actuator commands based on the vehicle-level commands; and
transmitting the target actuator commands to at least one actuator.

16. The method of claim 15, the method further comprising receiving the vehicle-level commands.

17. The method of claim 16, wherein the vehicle-level commands comprise a speed profile data, a front steering command, road bank data, road grade data, and road curvature data during the AV mode of operation.

18. The method of claim 17, the method further comprising translating the speed profile data, the front steering command, the road bank data, the road grade data, and the road curvature data to a corresponding yaw rate and relative positional data.

19. The method of claim 16, wherein the vehicle-level commands comprise a drive torque request, a brake torque request, a front steering command, road bank data, road grade data, and road curvature data during the manual mode of operation.

20. The method of claim 19, the method further comprising translating the drive torque request, the brake torque request, the front steering command, the road bank data, the road grade data, and the road curvature data to a corresponding yaw rate and relative positional data.
